(19) United States
(12) Patent Application Publication
(10) Pub. No.: US 2014/0099994 A1
(43) Pub. Date: Apr. 10, 2014

(54) ELECTRONIC CAMERA EMBODYING A PROXIMITY SENSOR

(71) Applicant: NVIDIA CORPORATION, Santa Clara, CA (US)

(72) Inventors: Lars Bishop, Durham, NC (US); Keith Galocy, Santa Clara, CA (US); David Chait, Bedford, MA (US)

(73) Assignee: NVIDIA CORPORATION, Santa Clara, CA (US)

(21) Appl. No.: 13/644,418

(22) Filed: Oct. 4, 2012

(51) Int. Cl. H04W 88/02; H04N 5/225

(52) U.S. Cl. 455/556.1; 348/373; 348/E05.024

(57) ABSTRACT

Provided is an electronic camera. The electronic camera, in one embodiment, may include a camera chassis, as well as a shutter button coupled to the camera chassis. Further in accordance with this embodiment, the electronic camera may include a proximity sensor coupled to the camera chassis, wherein the proximity sensor is configured to pre-enable one or more camera features.

### TECHNICAL FIELD

This application is directed, in general, to an electronic camera and, more specifically, to an electronic camera embodying a proximity sensor.

### BACKGROUND

With the rapidly decreasing prices thereof, electronic cameras have become a common purchase of professional photographers, semi-professional photographers, and beginner photographers alike. Accordingly, what is needed in the art is an electronic camera that is suited for the entire spectrum from professional photographers to beginner photographers.

### SUMMARY

One aspect provides an electronic camera. The electronic camera, in one embodiment, includes a camera chassis, as well as a shutter button coupled to the camera chassis. Further in accordance with this embodiment, the electronic camera includes a proximity sensor coupled to the camera chassis, wherein the proximity sensor is configurable to pre-enable one or more camera features.

Another aspect provides a communications device. The communications device, in one embodiment, includes a chassis having wireless communications circuitry located therein, an antenna coupled to the wireless communications circuitry proximate the chassis, and a touch screen display coupled to the chassis. The wireless communications device, in this embodiment, further includes an electronic camera. The electronic camera, in this embodiment, includes 1) electronic camera circuitry located within the chassis, 2) a shutter button associated with the electronic camera circuitry, and a proximity sensor associated with the touch screen display, the proximity sensor configured to pre-enable one or more camera features when a user's appendage hovers a prescribed distance above the proximity sensor.

### BRIEF DESCRIPTION

Reference is now made to the following descriptions taken in conjunction with the accompanying drawings, in which:

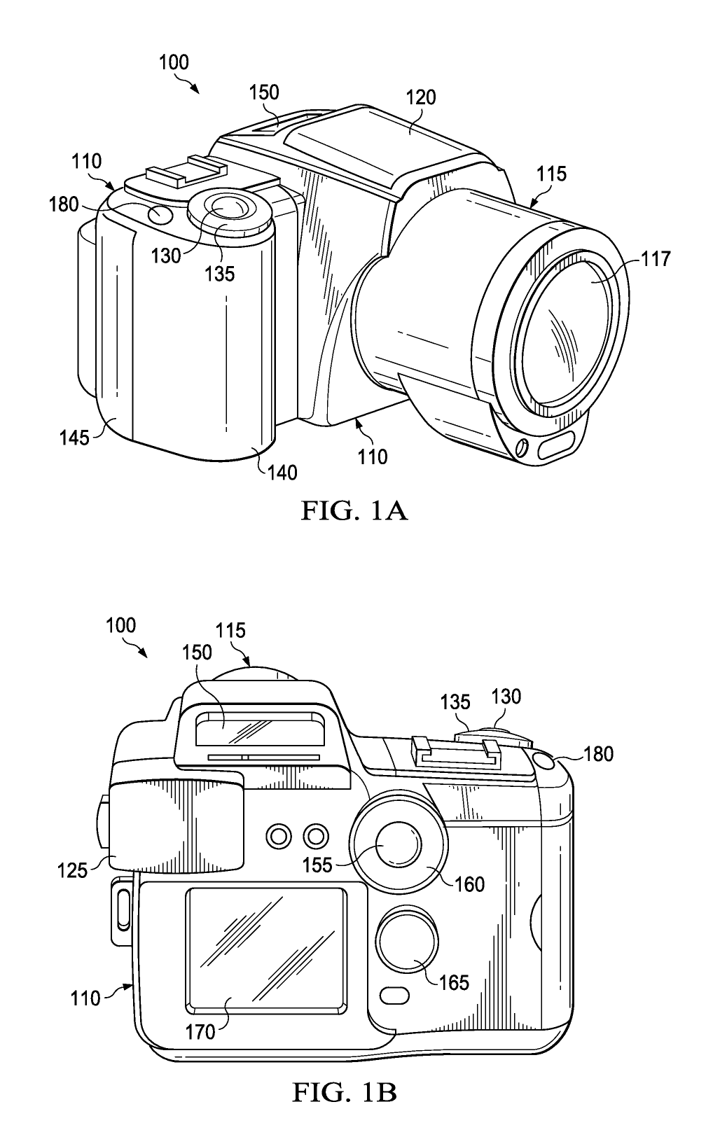

FIGS. 1A and 1B illustrate one embodiment of an electronic camera in accordance with the disclosure; and

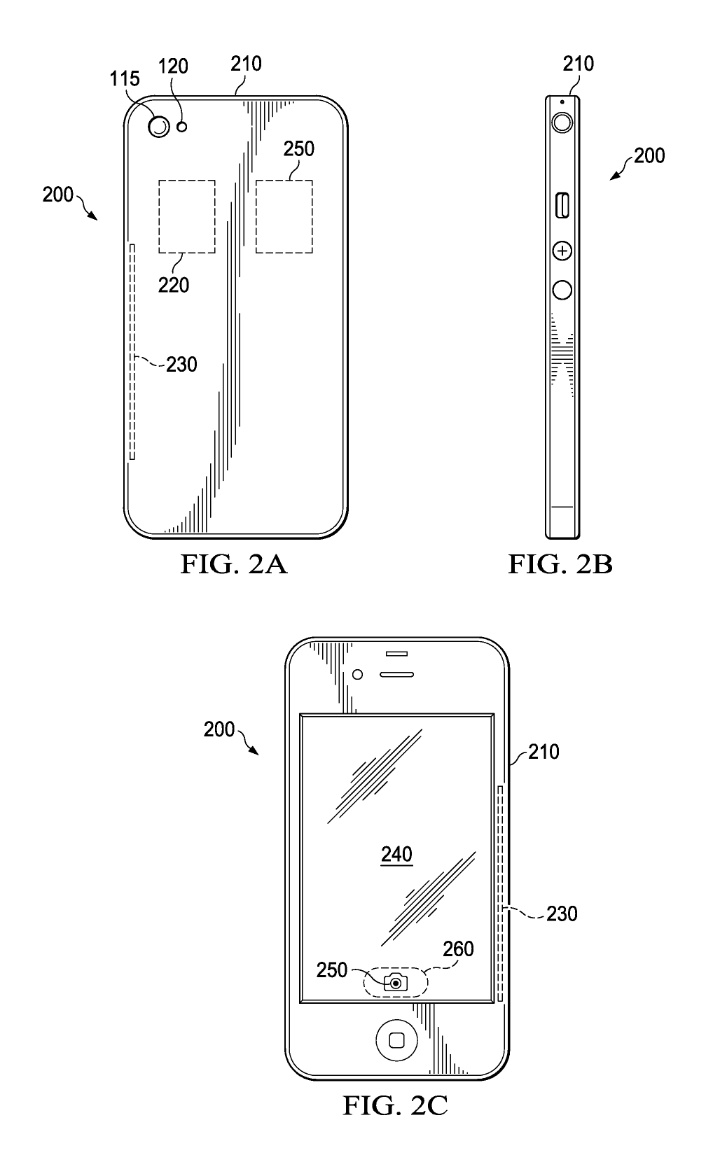

FIGS. 2A through 2C illustrate one embodiment of a communications device including an electronic camera in accordance with the disclosure.

### DETAILED DESCRIPTION

Many current electronic cameras use an explicit two-stage button to allow a photographer to indicate that a photo is about to be taken without yet taking the photo. Common uses of the first (half-press) stage of the explicit two-stage button include running the auto-focus and auto-exposure computations, among others. While this can allow for a complex “lock focus and recompose” behavior favored by professional photographers, it also has value to less skilled photographers, in that it minimizes the latency between the final act of requesting a photo (full-press) and the actual photo being taken. If the photographer allows the camera to complete auto-focus and auto-exposure before pressing the shutter button fully, he/she can have much more accurate control of the moment that the photo will be taken (since the camera will have already prepared at the time the shutter is half-pressed).

In practice, the typical photographer does not know, or care, that this feature exists. As a result, a typical picture-taking methodology begins by picking up a camera and holding a finger on (or slightly above) the shutter button without depressing it at all, waiting, tracking the subject for the exact moment that he/she wishes to take a photograph, and then quickly pressing the shutter button instantly from unpressed to fully-pressed in a single motion. Unfortunately, this leads to a sizable latency between the user requesting a photo and the photo actually being captured. This is because the camera has no idea that a photo is about to be taken until the moment the photographer requests it. At that point, the camera is forced to complete its auto-focus and auto-exposure computations before it can take the picture. The user perceives this as “shutter lag”, and is often annoyed by “missing the shot”.

The present disclosure acknowledges that while a typical photographer normally does not think to half-press the shutter button (in fact, a typical photographer may be oblivious to the existence of the feature), the photographer often rests his/her finger lightly on, or hovers his/her finger slightly above, the shutter button “to be ready”. With this acknowledgment in mind, the present disclosure takes advantage of this almost subconscious behavior on the part of the photographer, and includes a proximity sensor, as a part of an electronic camera, to pre-enable one or more camera features, thereby determining a photographer's intent (e.g., the intent to prepare to take a photograph). Accordingly, in one embodiment, the proximity sensor is configurable to enable one or more camera features at a time, or in a way, that is different from the typical way that camera feature would be enabled. The ability to pre-enable camera features using the proximity sensor has significant advantages.

The term “electronic camera”, as used herein, is intended to refer to a camera that embodies electronics to take a picture. Specifically, an electronic camera may take still photographs, or video, by recording images on an electronic image sensor, as opposed to on traditional film medium. Electronic cameras are also often referred to as digital cameras, and include without limitation digital point and shoot cameras, digital SLR cameras, camera phones, etc, whether they take still photos or video.

The term “proximity sensor”, as used herein, is intended to refer to a sensor that detects the presence of an object without being depressed. Accordingly, proximity sensors include sensors that detect the presence of an appendage, for example, a finger, even though the appendage is just resting upon, and not depressing, the proximity sensor. Proximity sensors additionally include sensors that detect the presence of an object, such as an appendage, when the object is hovering slightly above the sensor, even though the sensor is not physically being touched. The term proximity sensor does not, however, include sensors that the only way to activate the sensor is by depressing them.

Embodiments of the present disclosure will be described hereinafter with reference to the accompanying Figures. In the following description, the constituent elements having substantially the same function and arrangement are denoted by the same reference numerals, and a repetitive description will be made only when necessary.

As is shown in FIGS. 1A and 1B, an electronic camera 100, according to a first embodiment of the present disclosure, comprises a camera chassis 110. The camera chassis 110, in the illustrated embodiment includes a lens chassis 115 as a portion thereof. While the lens chassis 115 may or may not be removable or interchangeable based upon a selected electronic camera 100 type, the lens chassis 115 forms a part of the camera chassis 110. The lens chassis 115, in the illustrated embodiment, includes a camera lens 117. The electronic camera 100, as shown in FIGS. 1A and 1B, is provided with a flash 120 having a light-emitting portion arranged therein, and an optical finder 125 for observing a target object during picture taking. The electronic camera 100 may further include a shutter button 130. The shutter button 130, in one embodiment, is the primary feature for beginning the process of capturing a photograph or video image. The shutter button 130, as discussed above, may be a two-stage shutter button. Nevertheless, other embodiments exist wherein the shutter button 130 is only a single stage button.

The electronic camera 100 of FIGS. 1A and 1B may further include a zoom switch 135 coupled to the camera chassis 110. The zoom switch 135, in this embodiment, may be configured to zoom the lens 115, both optically and/or electronically, within a prescribed range. The electronic camera 100 may further include a grip section 140 and a card cover 145. The grip section 140 may be used for gripping the electronic camera 100 by a right hand during picture taking, and the card cover 145 may be used for opening and closing one or more card slots into which one or more memory cards may be inserted.

As is shown in FIG. 1B, the rear side of the electronic camera 100 may be provided with a mode display 150, a power switch 155, a mode dial 160, a cursor key 165, and an image display 170, all of which are coupled to the camera chassis 110. The mode dial 160 may be used for switching within a recording mode, and switching between the recording mode and a reproducing mode. The mode display 150 may be used for displaying a photographing mode, recorded numbers, and the like. The image display 170 may be used as an image-pickup finder in the photographing mode, and as a reproducing monitor for recorded photograph images in the reproducing mode. The mode display 150 and/or image display 170 may comprise touch screen displays, and as illustrated, are attached to the camera chassis 110.

The electronic camera 100, in accordance with the disclosure, further includes a proximity sensor 180. The proximity sensor 180, in accordance with the disclosure, is coupled to the camera chassis 110. The term “coupled,” at least as it related to the proximity sensor 180 being coupled to the camera chassis 110, excludes those scenarios wherein the proximity sensor 180 forms a part of a touch screen display.

When the proximity sensor 180 is coupled to the camera chassis 110 of the electronic camera 100, it may embody a variety of different locations. For example, in the illustrated embodiment, the proximity sensor 180 is located proximate the shutter button 130. More specifically, the proximity sensor 180 is located on an upper surface of the grip section 140. In yet another embodiment, the proximity sensor 180 is associated with the shutter button, and in one embodiment built into the shutter button 170. The inclusion of the proximity sensor 180 into the shutter button 170 takes advantage of the aforementioned subconscious behavior on the part of the photographer. In yet other embodiments, the proximity sensor 180 is positioned at other locations along the camera chassis 110 (e.g., the lens chassis 115), particularly at positions wherein a user's appendages are commonly positioned.

A variety of different proximity sensors 180 may be used and remain within the purview of the disclosure. As discussed above, the proximity sensors 180 may be triggered, depending on the design thereof, based upon just being touched by a user's appendage (i.e., without being depressed), or alternatively when a user's appendage is within a prescribed distance of the proximity sensor 190. The prescribed distance that the proximity sensor 180 is configured to detect the presence of a user's appendage depends on the specific proximity sensor 180 chosen. In one embodiment, the prescribed distance is up to about 20 millimeters. In another embodiment, the prescribed distance is only up to about 10 millimeters, and in even another embodiment the prescribed distance is only up to about 5 millimeters.

Each of the different distances, which may be programmable, have different advantages. In one embodiment, the proximity sensor 180 pre-enables different camera features based upon the distance a user's appendage is from the proximity sensor 180. For example, when the user's appendage is between 10 millimeters and 20 millimeters away, the proximity sensor 180 might awake the electronic camera 100 from sleep mode. When the user's appendage is between 5 millimeters and 10 millimeters away, the proximity sensor 180 might pre-enable image stabilization, and when the user's appendage is touching (but not depressing) the proximity sensor 180, the proximity sensor 180 might pre-enable autofocus.

Those skilled in the art of proximity sensors understand the different technologies that might be employed in various different electronic cameras and situations. For example, in one embodiment the proximity sensor 180 measures changes in capacitance (e.g., as a user's appendage approaches or touches the proximity sensor) to pre-enable the one or more camera features. In yet another embodiment, the proximity sensor 180 measures light, sound or radio waves to pre-enable the one or more camera features. Other proximity sensor technologies, so long as they may be configured for use with an electronic camera and configured to pre-enable one or more camera features, are within the scope of the instant disclosure.

Any number of different camera features may be pre-enabled by the proximity sensor 180 when it is triggered. For instance, depending on whether the camera is designed and/or being used by a professional photographer or novice photographer, the specific camera feature that is to be pre-enabled may change. In the case of professional photographers, the proximity sensor 180 might be used to pre-enable very special camera features, many of which are not known to the novice photographer. As the professional photographer is well aware of the benefits of the two stage shutter button, he/she might not waste the benefits of the proximity sensor 180 on such features. Nevertheless, in the case of professional photographers, the proximity sensor 180 might also be used to pre-enable camera features that preserve power. As one example, the proximity sensor 180 might be used to bring the camera out of a “standby” state, or might be used to pre-enable the image display 170, both of which relate to the savings of power.

As for the novice photographer, where the proximity sensor 180 has significant benefit, the proximity sensor 180 might be designed to pre-enable autofocus. Alternatively, the proximity sensor 180 might be designed to pre-enable image stabilization, or alternatively, face detection. In another embodiment, the proximity sensor 180 might be designed to pre-enable photo buffering. Additionally, in those situations wherein the camera may be used in low light conditions, the proximity sensor might be designed to pre-enable flash-circuit charging. While the proximity sensor 180 has been described as pre-enabling a single camera feature, it may also be configured to simultaneously, or even over a period of time, pre-enable multiple different camera features. Unlike the professional photographer discussed above, the benefit to the novice photographer may often be silent—the proximity sensor 180 allowing the camera to do what the novice photographers wanted without the novice photographer even knowing specifically what they wanted.

The specific camera feature that the proximity sensor 180 is configured to pre-enable may change on a camera by camera basis, for example depending on the primary purchaser of the electronic camera—professional, intermediate or novice photographer. Alternatively, the proximity sensor 180 may be programmable. For instance, the proximity sensor 180 might be quickly programmable based upon the expertise of the photographer. If during the set-up of the camera the user indicates that he/she is a novice photographer, the camera 100 might automatically configure the proximity sensor 180 to pre-enable autofocus and image stabilization when triggered. If during the set-up of the camera the user indicates that he/she is a professional photographer, the camera 100 might allow any feature of the camera to be user programmed to be pre-enabled by the proximity sensor 180. The type and number of camera features that may be pre-enabled by the proximity sensor are endless, and moreover, extend to features that are not currently known or used in cameras today, but are developed in the future. As an example, any feature obtainable using the shutter button 130, zoom button 135, mode display 150, power switch 155, mode dial 160, cursor key 165, and image display 170, among other camera buttons, may be pre-enabled using the proximity sensor 180.

Turning briefly to FIGS. 2A through 2C, illustrated are a back view, side view, and front view, respectively, of a communications device 200. The communications device 200, in this embodiment, is configured as a cellular telephone. The communications device 200 includes a chassis 210, wireless communications circuitry 220 located within the chassis 210, as well as an antenna 230 coupled to the wireless communications circuitry 220. The communications device 200 illustrated in FIGS. 2A through 2C further includes a touch screen display 240 coupled to the chassis 210.

The communications device 200, in this embodiment, is also designed as an electronic camera. Accordingly, the communications device 200 further includes electronic camera circuitry 250 located within the chassis 210, a shutter button 250 associated with the electronic camera circuitry 250. In the illustrated embodiment, the shutter button 250 is a user selectable feature on the touch screen display 240. Other embodiments, however, exist wherein the shutter button 250 is a stand-alone button on the chassis 210.

Furthermore, in accordance with the disclosure, the electronic camera portion of the communications device 200 may include a proximity sensor 260 associated with the touch screen display 240. The proximity sensor 260, like the proximity sensor 180 illustrated and discussed with respect to FIGS. 1A and 1B, is configurable to pre-enable one or more camera features when a user's appendage hovers a prescribed distance above the proximity sensor 260. Additional details about the location, functionality, etc. of the proximity sensor 180 illustrated with respect to FIGS. 2A through 2C may be found above. The electronic camera portion of the communications device 200 may additionally include a camera lens 117 and a flash 120, among other camera features.

Those skilled in the art to which this application relates will appreciate that other and further additions, deletions, substitutions and modifications may be made to the described embodiments.

What is claimed is:

1. An electronic camera, comprising:
a camera chassis;
a shutter button coupled to the camera chassis;
a proximity sensor coupled to the camera chassis, the proximity sensor configurable to pre-enable one or more camera features.

2. The electronic camera as recited in claim 1, wherein the proximity sensor is configured to pre-enable one or more camera features.

3. The electronic camera as recited in claim 1, wherein the proximity sensor is configured to pre-enable autofocus.

4. The electronic camera as recited in claim 1, wherein the proximity sensor is configured to pre-enable image stabilization.

5. The electronic camera as recited in claim 1, wherein the proximity sensor is configured to pre-enable face detection.

6. The electronic camera as recited in claim 1, wherein the proximity sensor is configured to pre-enable photo buffering.

7. The electronic camera as recited in claim 1, wherein the proximity sensor is configured to pre-enable flash-circuit charging.

8. The electronic camera as recited in claim 1, wherein the proximity sensor is configured to pre-enable an image display.

9. The electronic camera as recited in claim 1, wherein the proximity sensor is user programmable to pre-enable a specific camera feature.

10. The electronic camera as recited in claim 1, wherein the proximity sensor is configured to pre-enable the one or more camera features when a user's appendage touches, but does not depress, the proximity sensor.

11. The electronic camera as recited in claim 1, wherein the proximity sensor is configured to pre-enable the one or more camera features when a user's appendage is within a prescribed distance of the proximity sensor.

12. The electronic camera as recited in claim 1, wherein the prescribed distance is up to about 20 millimeters.

13. The electronic camera as recited in claim 1, wherein the prescribed distance is up to about 10 millimeters.

14. The electronic camera as recited in claim 1, wherein the proximity sensor is associated with the shutter button.

15. The electronic camera as recited in claim 1, wherein the proximity sensor is built into the shutter button.

16. The electronic camera as recited in claim 1, wherein the proximity sensor uses a change in capacitance to pre-enable the one or more camera features.

17. The electronic camera as recited in claim 1, wherein the proximity sensor measures light, sound or radio waves to pre-enable the one or more camera features.

18. The electronic camera as recited in claim 1, further including cellular communications circuitry located within the camera chassis such that the electronic camera may also function as a communications device.

19. A communications device, comprising:
a chassis;
wireless communications circuitry located within the chassis;
an antenna coupled to the wireless communications circuitry proximate the chassis;
a touch screen display coupled to the chassis; and
an electronic camera, including;
electronic camera circuitry located within the chassis;
a shutter button associated with the electronic camera circuitry; and
a proximity sensor associated with the touch screen display, the proximity sensor configured to pre-enable one or more camera features when a user's appendage hovers a prescribed distance above the proximity sensor.

20. The communications device as recited in claim 19, wherein the shutter button is a user selectable feature on the touch screen, the shutter button configured to begin taking a photograph or video when the user's appendage physically touches the shutter button.
